(19) United States
(12) Patent Application Publication
(10) Pub. No.: US 2014/0358394 A1
(43) Pub. Date: Dec. 4, 2014

(54) Jolt and Jar Recorder System and Methods of Use Thereof

(71) Applicant: LXTCH, LLC, PHILADELPHIA, PA (US)

(72) Inventor: Anthony Dean Picciotti, Philadelphia, PA (US)

(21) Appl. No.: 14/460,884

(22) Filed: Aug. 15, 2014

Related U.S. Application Data
(63) Continuation-in-part of application No. 13/767,895, filed on Feb. 15, 2013, now abandoned.

(51) Int. Cl. G06F 21/62; G06F 21/64

(52) U.S. Cl. CPC G06F 21/6218; G06F 21/64
USPC 701/70; 701/1

(57) ABSTRACT

A system for monitoring and recording vehicle and passenger data constantly during operation, which combines, stores and analyzes data. A recording device connects to systems that may include vehicle status, video, audio or other data sensor and collection interfaces. Data may be selectively retrieved wirelessly and stored encrypted to preserve authenticity. Data collected could also include: temperature (inside/outside); weather conditions; tire slip; roll, yaw, pitch; altitude; speed and changes to speed; GPS data; any available radio signals and the strength and source of those signals; vibration; sound level and changes; air pressure; light and changes; intrusion; moisture; humidity; inertia/gravitational forces; vehicle (OBD) error codes; vehicle weight; tire pressure; location of the device within the vehicle; engine RPM (and other OBD available data); time/date, and passenger embark, riding, and disembark data. These data can be later decrypted to analyze driver performance or verify the existence of a claimed accident.

### CROSS REFERENCE TO RELATED APPLICATIONS

The present application is a continuation-in-part of and claims the priority and benefit of U.S. patent application No. 13/767,895 titled “Jolt and Jar Recorder System” filed on Feb. 15, 2013, which claims the priority and benefit of U.S. Provisional Patent Application 61/742,629 titled “Jolt and Jar Recorder” filed Aug. 15, 2012, the entireties of which are incorporated herein by reference.

### FIELD OF THE INVENTION

The present invention relates generally to a system for electronic monitoring, data collection and analysis in relation to a variety of vehicle and passenger data including video and/or physical data. In particular, the present invention relates to a system wherein a variety of data collection receivers, sensors and devices are configured to continuously acquire and transmit data to an on-board computer including a processor aided by memory so that the data can be encrypted with software in a secure manner for later use in forensic animation, as admissible evidence, for data mining relevant vehicle and passenger information, or in other systems.

### BACKGROUND OF THE INVENTION

Unsafe driving causes significant costs in terms of direct loss, consequential loss, and societal loss due to a multitude of issues that must be dealt with in the aftermath. One major aspect is the allocation of responsibility for direct costs. For example, when more than one vehicle is involved, the determination must be made which vehicle is at fault and is thus generally held liable for the damages. As another example, if a passenger on a mass transit vehicle is injured, it is important to determine whether the passenger or the operator or the Transit Authority was negligent, or both were contributorily negligent. While negligent operation of a vehicle represents a dangerous threat for private individuals, it is exponentially more difficult for transportation entities due to the number of vehicles in operation and the number of miles each vehicle operates annually. Traditionally, accident prevention and monitoring concepts have focused heavily on individual private vehicles and determining fault or, in the alternative, on protecting private vehicles from theft. While these concepts are practical for individuals, they do not address the more complex concerns of transportation related organizations, such as those that run public transportation or larger commercial transportation operations.

Causation of driving injuries is particularly important for assigning responsibility, evaluating risk, and designing preventative methods. Currently, determining the cause of injuries, such as those involving a single vehicle, automobiles, trucks, and railroad rolling stock is very difficult. While accident investigation art has developed significantly in recent years, a large portion of the information gained in accident investigation is typically not factual and open to a variety of interpretations.

As an example of the difficulties encountered in an injury investigation, it is not uncommon for a passenger injury to occur with either no witnesses to the incident or, even if there were witnesses, unidentified witnesses. Also, it is a well-known phenomenon that several witnesses to the same accident often provide different interpretations. As another example, a vehicle may be so severely damaged that it is not possible to determine the effect of a mechanical failure in causing or aggravating an accident. In still another example, speed factors, braking factors, and swerving factors, all of which accident investigators consider vital in determining the cause of an accident, are difficult to ascertain. While the extent of damage to a vehicle and length of skid marks are often valuable indicators of speed, they are open to conjecture because of other factors, such as the amount of damage on the vehicle before the accident occurred and the distance a vehicle traveled before a driver applied brakes to cause skid marks. Further, where the speed and/or directional travel of the vehicle was aggressively altered, but no external physical evidence such as skidding occurred due to speed or environmental conditions (e.g., snow, rain), such data is of no beneficial use.

With public and commercial transportation, the major concern shifts from assigning fault of the accident to passenger liability. Injuries may arise by improper operation of the transportation vehicles or through accidents not due to the fault of the driver. A major problem for transportation organizations lies with individuals who claim to have sustained injury while riding the vehicle, but may not have been present and are fraudulently fabricating the incident. Further, notice of injuries may not be made available until many months after the event as the end of the statute of limitations draws near. A means for ascertaining the identity of the vehicle's passengers and monitoring the operation of the vehicle, as well as a multitude of status indicators, which may be used to provide information related to the vehicles operation at the exact moment in question, would be extremely useful to the mitigation of liability issues. A monitoring system that is able to ascertain the presence of a specific passenger on the vehicle and to determine and report the vehicle status at the exact moment in time that the alleged former passenger claims to have been injured would allow transportation authorities to confidently settle legal matters based on irrefutable information concerning the operation of the vehicle in question and whether it was being operated within federally-mandated thresholds. Further, it is necessary that the information be retrievable for a period that exceeds the statute of limitations for the relevant jurisdiction.

Automobile accident detection systems are relatively common in the art. Upon the occurrence of an automobile accident, typical detecting systems may obtain pictures, video images and sounds of the accident, and record the time of the accident and the status of the traffic lights at the time the accident occurred. This information can then be sent to a remote location where emergency crews can be dispatched. The information may be further examined and forwarded to authorities in order to determine fault and liability. Such detection systems are location specific and are often set up in specific intersections, resulting in only a limited number of accidents occurring within a detection zone. Further, outfitting every intersection with accident detection would be extremely costly and generate enormous amounts of data. It is possible to monitor locations that are likely places for accidents to occur, however, without intelligence, this process may be inefficient and unproductive. Likewise, without immediate and efficient communication of the information obtained, benefits of the monitoring are limited.

In other instances, accident detection systems are centered on monitoring and controlling a limited number of statistics related to a particular vehicle, such as the acceleration or G-forces. While these may be suitable for single private vehicles, they are insufficient in how and what is retained. Alternatively, a number of prior art techniques are available for predicting the occurrence of an accident. Some of these require an extended period for an automated system to analyze the data, and thus substantially delaying any report generated. In others, the accuracy of the system depends on environmental conditions, such as lighting or time of day. While these systems may prove useful for urban planning or in other city development functions, they do not address any of the liability issues that transportation entities encounter.

Numerous patents have issued and applications published in the field of vehicle monitoring. While relevant to the field in general, these prior art devices and systems each have drawbacks and fail to address the needs of larger transportation providers addressed by the present invention. The present invention addresses both the need for maintaining ridership, accident, event, and anomaly data, as well as the need for historical, cumulative and real-time vehicle monitoring. Both of these functions fill voids in the art.

Several inventions address accident monitoring for a single private personal vehicle or for multiple vehicles; however, these inventions rely upon external cameras or microphones and constant monitoring. Reliance on external devices at intersections makes monitoring costly and difficult.

A variety of patents and publications address in-vehicle status monitoring in a limited manner that is not suitable for use by larger transportation entities. These patents typically monitor vehicles, look for deviations in performance and alert those supervising the vehicles of changes. These inventions do not provide for sufficient means of storage and retrieval to satisfy the human safety and litigation needs of a larger transportation entity.

Ogino, U.S. Patent Publication No. 2010/0250052, is directed toward an in-vehicle monitor for monitoring a status of a vehicle. The invention comprises a monitoring means for monitoring the status of the vehicle; a determination means for determining—based on the status of the vehicle - whether an obstacle interrupts an operation of an operation object when a user inputs an operation instruction for operating the operation object; and a controller for controlling the operation object to execute the operation corresponding to the operation instruction when the determination means determines that the obstacle does not interrupt the operation, and for controlling the operation object to execute another operation different from the operation corresponding to the operation instruction when the determination means determines that the obstacle interrupts the operation.

Lemelson, U.S. Pat. No. 4,671,111, is directed to a vehicle performance monitoring system employing one or more accelerometers operative to generate output signals of acceleration and deceleration of a vehicle as the vehicle operates. Such signals are electronically processed and either immediately analyzed by a computer prior to monitoring or recording same or are recorded and later analyzed by an onboard computer or a remote computer which communicates with a memory part of the system located in the vehicle. Data is communicated by pluggable lines or short wave communication.

Nicol et al., U.S. Pat. No. 5,548,273, is directed toward an apparatus for monitoring operation of a vehicle apparatus that includes sensors for sensing G-forces on the vehicle and for generating output signals proportional to a forward G-force, a reverse G-force, a left direction G-force, and a right direction G-force on the vehicle. The apparatus permits an authorized user to set a selected maximum G-force limit for each direction. The apparatus stores G-force output signals generated by the sensors which are higher than the maximum selected limit for each direction. An oven heats each sensor to a substantially constant predetermined temperature, thereby improving the accuracy of the output signals from the sensor upon fluctuation of an ambient temperature adjacent the apparatus. The apparatus detects when the apparatus has been disconnected from a power supply to alert an owner of the vehicle that the vehicle may have been driven without the monitoring apparatus in operation.

The Orgino, Lemelson and Nicol patents each describe inventions which monitor a single vehicle and provide immediate or delayed alerts to a supervisor should deviation from the defined parameters occur. While these inventions might prove useful in smaller and more personal situations, they suffer from several issues that make them unsuitable for use with a large transportation entity. Primarily, they do not provide for storage beyond that designated immediately within the vehicle. This severely limits capacity for video, picture and other vehicle data storage. The present invention fills this void, by providing a secure monitoring system capable of maintaining data for years, in a manner suitable for courtroom use.

Kikinis, U.S. Pat. No. 5,815,093, is directed toward a vehicle accident recording system that employs a digital camera connected to a controller, a non-volatile memory, and an accident-sensing interrupter. The controller accesses images from the digital camera periodically and stores the images in a limited space of n sectors. After all n sectors are filled, each new image is overwritten to the oldest stored image. In the event of an accident, the interrupter causes the operation of storing images to cease. The result is a recorded history of n images spanning a time period up to the incidence of an accident of the number of images stored times the average time period between images. In a preferred embodiment, the system has a communication port whereby the stored images may be downloaded after an accident to a digital device capable of displaying the images, thereby providing a visual record of the time period immediately preceding an accident. In alternative embodiments vehicle operating data is recorded, positional information is accessed and recorded, and on-board control routines convert raw data to meaningful information.

The Kikinis invention suffers from an issue similar to the Orgino, Lemelson and Nicol patents. The control in the Kikinis invention saves a plurality of pictures taken in the time leading up to a crash event. Saving picture helps preserve space and attempts to substitute for video. However, the Kikinis invention fails to provide a means to preserve multiple video recordings related to the accident for a long term. Additionally, there is no means of encryption, meaning that data, while informative, may suffer evidentiary issues if it is to be used in a legal setting. Further, none of these inventions preserve data from an acceleration, deceleration or swerving event where there is no impact with another vehicle. As such, they are of no use to a transit authority that becomes aware of an alleged soft tissue injury to a passenger arising from an acceleration, deceleration or swerving event where there is no impact with another vehicle 6 months after the alleged anomalous vehicle operation. Ascertaining fault and liability in these non-impact anomalous operation events is a specific function of this invention.

Tuff, U.S. Pat. Nos. 7,853,375 and 8,180,522, is directed toward a system and method for monitoring a motor vehicle. The system includes a sensor unit for collecting at least one vehicle statistic and a portable device for displaying the vehicle statistics. The portable device requests the vehicle statistics from the sensor unit at regular intervals or in response to a particular event and displays statistics on a built-in display screen. In one embodiment, the portable device may be attached to the keys used to operate the vehicle being monitored.

The Tuff patents provide for inventions that monitor basic vehicle statistics and store the information in a small onboard unit such as a key chain with internal memory. While these devices are useful for compiling basic information regarding vehicle performance, they are not designed with the intent to monitor or detect accidents. Nor are they designed to ascertain if a passenger was present on a vehicle at the time of the alleged anomalous vehicle operation. In particular, they are not capable of providing complete, accurate data that might be useful in a court of law. The present invention provides such data, and stores said data in a manner allowing years of records for thousands of vehicles to be accessed and used as needed, something that the Tuff inventions are simply not designed to do.

Oyagi et al., U.S. Pat. No. 7,212,103, is directed toward a monitoring system which can monitor a plurality of vehicles including vibration sensing units, each sensing a vibration of the associated vehicle, a sensed time specifying unit, which specifies an instant at which the vibration of the vehicle is sensed by the vibration sensing unit, and an abnormality determining unit which determines, when a vibration of one of the vehicles is sensed by the associated vibration sensing unit, whether the vibration is caused by preparations for theft with respect to the vehicle or the vibration is caused by environmental influences on the vehicle. The abnormality determining unit carries out the determination of ground sensing results obtained by the vibration sensing units of the respective vehicles and as a result of specification carried out by the sensed time specifying unit. With this, there is a possibility of incorrectly identifying a vibration not being attributed to preparations for theft as a vibration attributed to preparations for theft.

Other inventions in the prior art, such as the Oyagi invention, are directed toward detecting a single sort of event, in this instance vibration. This is useful for theft prevention, but does not accomplish the goal of monitoring a large fleet of vehicles for accidents. Like the other previously mentioned prior art, the Oyagi invention does not provide a means for archiving and retrieving information in a manner suitable for courtroom usage.

Other patents isolate single locations for monitoring, such as a parking lot or intersection. For example, Japanese Patent Application No. 8-162911 entitled “Motor Vehicle Accident Monitoring Device,” discloses a system for monitoring traffic accidents including a plurality of microphones and video cameras disposed at an intersection. Collision sounds are chosen from among the typical sounds at an intersection. The source of the collision sounds is determined by comparing the time differences of the sounds received by each of the microphones. Image data from the cameras is recorded upon the occurrence of the collision. However, the Japanese reference discloses a system that is constantly photographing and recording the accident scene thereby wasting resources.

Similarly, Lagassey, U.S. Patent Publication No. 2008/0252485 and U.S. Pat. No. 7,348,895, are directed toward a system for monitoring a location to detect and report a vehicular incident. The Lagassey inventions comprise a transducer for detecting acoustic waves at the location with an audio output; and a processor for determining a probable occurrence or impending occurrence of a vehicular incident, based at least upon the audio output. The invention further comprises an imaging system for capturing images of the location, and having an image output; a buffer, receiving said image output, and storing at least a portion of said images. The images stored commence at or before said determination of an accident and are selectively sent via a communication link to a remote location with information identifying the location. Information stored in said buffer is preserved at least until an acknowledgement of receipt is received representing successful transmission through said communication link with the remote location.

There is currently a void in the art for vehicle centric accident detection and monitoring systems, capable of identifying passengers and storing sufficient operational data so as to provide legal support for large transportation organizations. What is needed is an apparatus and method to provide a user with readily accessible refined vehicle operation information without the problems associated with hand recording. Also needed is the ability to ascertain the existence of a rider on a specific vehicle and an apparatus and method to automatically provide comprehensive and factual vehicle operational and accident data to enhance an accident investigator's ability to determine cause and legal liability.

### SUMMARY OF THE INVENTION

Computerized methods and systems are provided for collecting, recording and storing evidence of ridership and vehicle event data using encryption software in an on-board computer system, and later transmitting the encrypted information to a back end server for secure storage and possible later use in analyzing and recreating specific movements of the vehicle during the event, as well as confirming whether a person(s) was (were) actually present on a vehicle and, if so, actually during a vehicle event.

The computerized system comprises at least one on-board computer having a processor and memory for data storage, data collection devices, encryption and decryption software to preserve the integrity and validity of the information, that communicate through wired and/or wireless communication systems with the data collection devices and the back end server computer systems. The on-board computer system functionally integrates data collection devices, receivers and sensors capable of collecting and independently recording GPS coordinates, velocity, acceleration, deceleration, changes in sound (DB meter), vibrations, pitch, yaw, time, identifiable radio signals, video and/or photo images and other electronically-collectable vehicle data and information.

Additionally, the on-board computer system comprises authentication software to determine where in the vehicle the data collection devices, receivers, and sensors are located. This authentication allows the information collected to be matched with a specific device, which may be necessary in instances in which there is more than a single device on a vehicle (e.g., multicar train, double bus).

The system can collect vehicle event data from the on-board data collection devices, receivers, and sensors, and then encode the data using encryption and authentication software and systems to prevent tampering and to ensure admissibility in court and store the data on re-writable media, either a hard drive or flash memory, present with the on-board computer system. The system will generate a data checksum using a combination of the date and a hard-coded system ID as a ‘salt’, thus indelibly linking the collected information to both the device and the vehicle in which the device is located.

The system is specifically configured to collect and store forensic quality data, which is admissible evidence according to state and federal law, for determining the physical presence and experience of vehicle riders, and, more specifically, whether a passenger(s) has (have) been exposed to vehicle events including swerving, sudden stops, assorted bumps, accidents, and unexpected movements. The data collected by the present invention allows a determination to be made of the specific movements of the vehicle during a specified time period. These movements included typical accelerations and decelerations, as well as any sudden jolts, jars or other movements that may be associated with an accident.

The system and methods of the present invention may be employed on vehicles, to record data in perpetuity, for later retrieval, or to record and transmit to a data storage system, and may also be integrated with forensic animation or other software. In particular, the data may be used for introduction into courtroom evidence. Still more specifically, the evidence may be used to defend personal injury cases based on allegations made that injury and damages occurred during vehicular event.

The on-board computer device also contains a wired and wireless network capability with the ability to upload and download data and other electronic communications in both real time, and post ride data processing when a vehicle returns to a depot, at the end of a trip, or at another location or predetermined time so that data can be transmitted from the vehicle into a storage system.

The present invention provides an economical, accident detection and recreation system and methods that will preserve valuable data for legal challenges arising over time.

The present invention provides systems and methods for constant monitoring of all vehicles in a fleet, such as, for example, mass transit vehicles (busses, trains, subway cars, etc.), freight and commercial trucking and rail, rental vehicles, and aircrafts.

The present invention provides a physical device and methods and systems for monitoring the movements and events of a vehicle, including the vehicle status, dynamic vehicle data, and time and location stamped or referenced video and/or photo footage of riders/passengers embarking on, riding, and disembarking from the vehicle, as well as the vehicle itself.

The present invention provides efficient and economical methods and systems to store and maintain the data until the statute of limitations period is exceeded, in a manner that is efficient and economical.

The present invention provides methods and systems to use the data with forensic software, such that the data is admissible in court, for legal proceedings.

Additional objects, features, and advantages of the invention will become apparent to those skilled in the art upon consideration of the following detailed description of a various embodiments exemplifying embodiments for carrying out the purpose of the invention.

### DESCRIPTIONS OF THE DRAWINGS

Although the characteristic features of this invention will be particularly pointed out in the claims, the invention itself and manner in which it may be made and used, may be better understood by referring to the following description taken in connection with the accompanying drawings.

FIG. 1 is a flow chart outlining a process by which the present invention records and preserves data for use in court proceedings.

FIG. 2 is a flow chart outlining a process by which data is decrypted for use in court proceedings.

### DETAILED DESCRIPTION OF EMBODIMENTS OF THE INVENTION

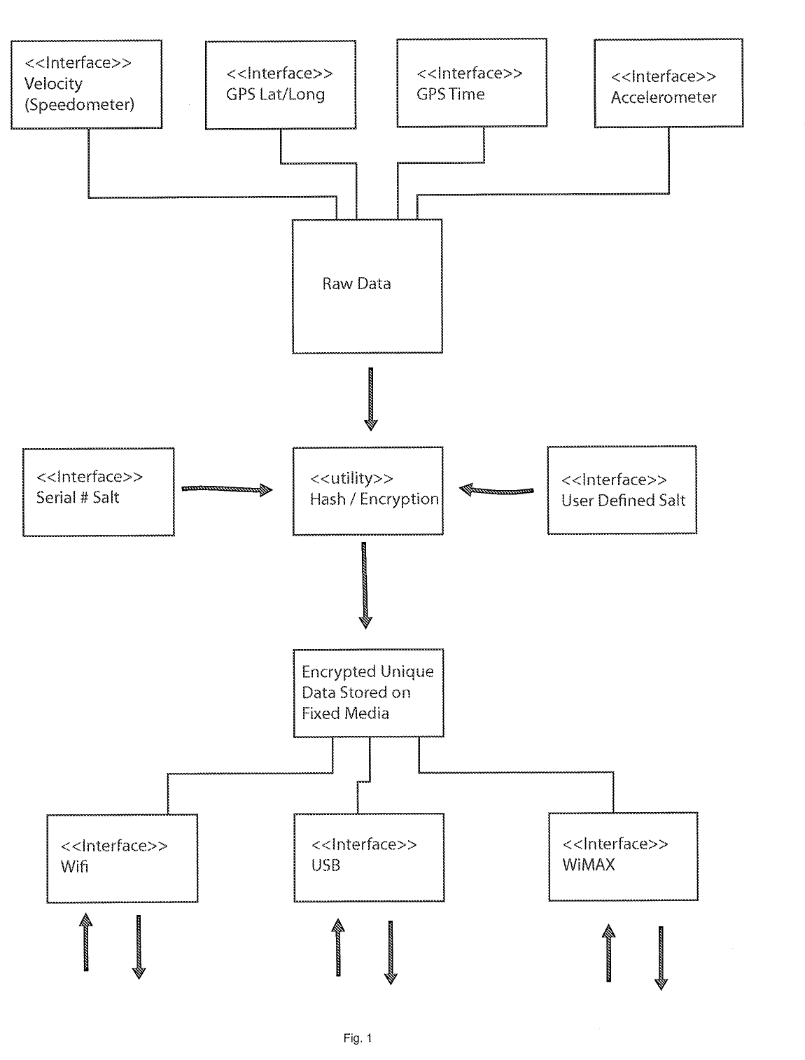

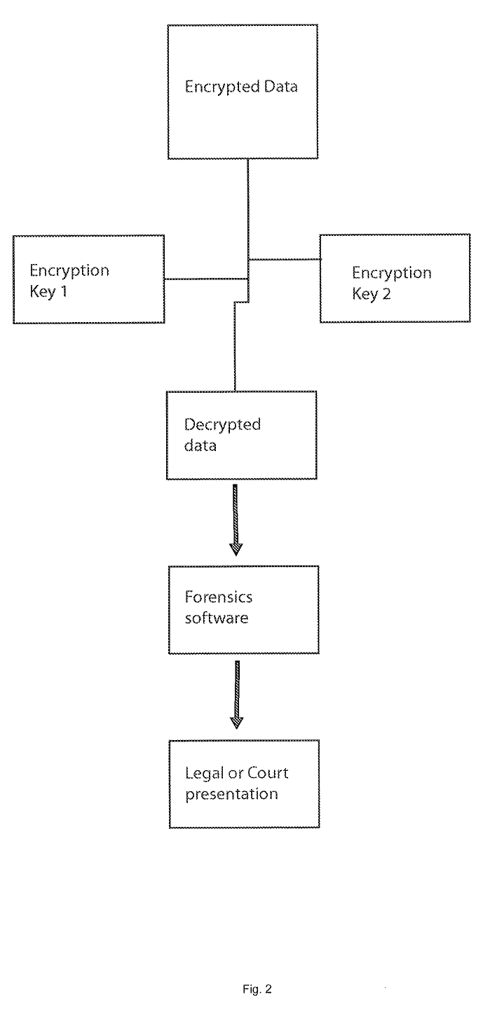

Illustrative and alternative embodiments of the invention are described in the application, in certain instances in reference to FIGS. 1 and 2. The invention is a computerized system comprising (1) at least one on-board vehicle computer system that collects vehicle event data from data devices, sensors and receivers, and then processes the collected data using software that encrypts and authenticates the collected data before storing the encrypted/authenticated data in a data storage device in communication with the on-board computer system, (2) a wired and/or wireless telecommunications system used to receive, transmit and download the encrypted and authenticated data from the on-board computer system to (3) a back end computer server system that processes and securely archives the encrypted/authenticated data in a data vault and that also provides functionality to mine for and retrieve the stored data for later use.

Referring now to FIG. 1, a flow chart illustrates an illustrative process by which the computerized systems collects, records and preserves vehicle data.

The present invention comprises at least one on-board computer system that includes a computer processor, memory for data storage, encryption software, I/O ports, and wired and/or wireless communication system configured to receive data collected by data collection receivers, devices and sensors, as well as cameras positioned on and in the vehicle, all of which are capable of collecting and independently recording vehicle data including, but not limited to: GPS coordinates, velocity, acceleration, time, and other vehicle data and vehicle event information. The wired and/or wireless network capability of the on-board computer system provides the functionality to receive, upload and download data and other electronic communications in both real time, and post ride data processing.

In an exemplary, non-limiting embodiment, the on-board computer system is an Intel Atom vehicle computer D425/D525 (AR-V6002FL) having an Intel processor with 1GB of memory, video graphic controller and VGA port interface, flash memory and SATA port, I/O expansion slots, Ethernet connection, serial port, USB port, and other I/O connections, and an operating system that supports Microsoft operating systems and Linux. Alternative embodiments of suitable on-board computer systems include any computer comprising a processor, memory storage device, and wired and/or wireless telecommunication capabilities.

More specifically, the present invention provides a variety of in vehicle data collection devices, receivers, and sensors to record raw data for a transportation vehicle. The vehicle data collection devices may include cameras for collecting video and photographs, GPS devices to identify coordinates and provide GPS Timestamps, an accelerometer, as well as any other potentially useful status devices. The data collection devices, receivers, and sensors obtain raw data, then pass the raw data on to a hash/encryption software utility application executed by the processor of the on-board computer system. The encryption application encrypts the data using a hash tag based on the vehicle, as well as another security tag. Once encrypted, the data is stored temporarily on the vehicle in a fixed storage media, such as a hard drive or flash drive, until the vehicle reaches a location or time at which the encrypted, stored data is transmitted through a wireless telecommunications network (e.g., cell phone network, satellite, Wi-Fi network (WLAN, wireless mesh, wireless MAN, wireless WAN), terrestrial microwave network, global area network, and radio and spread spectrum technologies) and/or wired telecommunications network (e.g., cable (wired or fiberoptic), Ethernet, and the like) to to the back end server system which securely receives and stores the data, such as, for example, in a data vault for later use.

Vehicle data, such as speed and distance, may be tracked with the on-board computer system. For instance, speedometers, accelerometers, GPS technologies and SAE J1939 and OBD-II ports that are currently available in some or all vehicles. OBD-II ports, for example, are available in all post-1996 vehicles. An OBD-II port (which is similar to the J1939 system on mass transit vehicles) is a standardized digital communications port designed to provide real-time data regarding vehicle functioning in addition to a standardized series of diagnostic trouble codes. This data may be collected by connecting a device to the OBD-II port that is capable of communicating with, for example, the SAE J1850 standard.

Radio frequency information and other electronic data may be collected by devices and transmitted to the on-board computer system, as well, to be used to determine the presence and location of an individual relative to the vehicle operation. This might include signals such as those emitted from cellular phones. Illustrative, non-limiting examples of these types of data collection devices include sound wave detectors, motion detectors, radiation detectors, radio wave detectors (WiFi or Bluetooth), and RFID receivers.

Video and photographs may also be collected by cameras onboard a vehicle. The camera(s) may be positioned with line-of-sight to relevant locations on the vehicle, such as, for example, doors, as well as the length of the vehicle. In specific embodiments, the camera may be positioned to provide a direct line-of-sight to entrance and exit locations so that, when the vehicle entrance(s) and exit(s) open, the cameras collect video and/or photographs of every passenger embarking on and disembarking from the vehicle. This data provides evidence of whether, when and where a person embarked on, travelled on, and then disembarked from the vehicle.

The encryption and authentication technology and software can be stored on and executed with the processor on the on-board computer that performs the functions of the invention in connection with encrypting and authenticating all data that is collected with the system, as well as for encrypting (and decrypting), compressing, and authenticating the stored data in the back end server/data vault. An illustrative, non-limiting example of such software comprises a secure hash algorithm (e.g., Sha-3) that provides a cryptographic hash functionality. The National Institute of Standards and Technology (NIST) published Sha-3 as a U.S. Federal Information Processing Standard (FIPS). Other encryption and authentication software can be used so long as the software performs the functions necessary to meet the purposes of the invention.

The back end server system comprises at least one computer processor, memory for data storage, encryption and decryption software, database software for data mining and retrieval, and wired and/or wireless telecommunication connections for communicating with the on-board computer system. The back end server system is configured to communicate with and download data from the on-board computer at predetermined times and locations. Non-limiting examples of the back end server may be a MySQL server or other data storage devices in communication with a computer processor and wire and/or wireless telecommunications systems.

The present invention also provides methods for collecting, recording and storing vehicle data using encryption and authentication software systems for later use in recreating the specific movements of the vehicle.

More particularly, the methods including collecting vehicle data from data collection devices, receivers, and sensors including cameras, encoding and authenticating the data using encryption software running on the on-board computer in order to prevent tampering and to ensure admissibility in court, storing the encrypted/authenticated data on a re-writable media, either a hard drive or flash memory, in communication with the on-board computer, and then later transmitting the stored data through a wireless and/or wired telecommunications network to secured data storage vault, where the date is compressed, encrypted, and duplicated. In an embodiment, the duplicated data is separated so that one set can be stored in a vault which allows data entry but not to exit (e.g., upload, no download) remotely with proof of chain-of-custody of evidence for later use. The data must be retrieved manually onsite to ensure that it has not been tampered with. The other set of data is stored in a searchable database so that the vehicle owner/operator (e.g., mass transit authority) can gain access to and search the database remotely.

The encryption and authentication software is operable on the on-board computer system to perform the encryption and authentication steps of the methods of the invention. Following collection and storage of the vehicle data on the on-board computer system, the computer system will generate a data checksum using a combination of the date and a hard-coded system ID as a ‘salt’, thus indelibly linking the collected information to both the device and the vehicle the device was located in. In an illustrative embodiment, collected vehicle data can be tagged and time-stamped by the on-board computer system in a manner that aligns the collected vehicle data with corresponding video and audio recordings.

Due to the size of video and/or photo data, it may be cumbersome, infeasible or undesirable to transfer all video and/or photo data, which is collected by camera(s) on the vehicle, to a backend server of the system. It is likely that a vehicle will have numerous cameras, each generating many gigabytes of video data each day. For this reason, and in certain embodiments, the video and/or photo data collected from a vehicle can be separated from the other vehicle data acquired by data collection devices, receivers, and sensors. The entire video and/or photo data from a vehicle run can be maintained in storage on the vehicle for a short time chosen by the user, likely 1-5 days, and the associated encrypted data collection (without video and/or photos) can be efficiently transferred to a back end server for preservation.

In another embodiment, specific time-limited video and/or photo data is taken of all passengers/riders entering and exiting the vehicle during each time the vehicle doors are opened. This more time-limited video and/or photo data may be associated and stored with vehicle data and later transferred from the vehicle through a wired or wireless telecommunications system to the back end server of the system. Most conveniently, a wireless method would represent a means of transferring data, as vehicles could park appropriately and allow an automated transfer of the interface data at predetermined times, locations and intervals. The associated data collected by the on-board computer system, including the passenger video and/or photo data provides a sufficient encrypted means to recreate any suspected accidents or events (or absence thereof), as well as correlating accident/event information with passenger/rider's presence (or absence) on the vehicle, in a manner that preserves the chain of custody of evidence, such that the data is legally admissible in court.

Referring now to FIG. 2, there is shown a flow chart demonstrating the extraction process of the data obtained from vehicle data collection devices, receivers, and sensors for court usage. Encrypted data including vehicle data and passenger/rider video and/or photo data can be decrypted using a series of keys, one likely defined by the user, and another held by the manufacturer and kept unknown absent court order. Should a court order be issued to decrypt the data, the code could be easily released. This preserves the chain of custody of evidence and the integrity of the encrypted data such that it will serve as viable evidence in any court proceeding. The two keys are applied to the encrypted data, decrypting the data to a format that may be used by forensic software to recreate the time period desired. The encryption could be utilized in a variety of manners. In a more basic sense, the encryption could leave any data collected un-encrypted, while encrypting and storing a checksum. This would allow changes to be detected, and allow the operating entity to make use of the data. In more sensitive situations the data might be completely encrypted, such that it may only be extracted when a legal need is present. The software may then be used to create a presentation as desired for courtroom use.

According to a first aspect of the present disclosure an in-vehicle monitor for monitoring a status of a vehicle including a status of an operation object, which is operated by a user, the monitor includes: a series of interfaces, including GPS coordinates, a GPS timestamp, an accelerometer, video recording and/or photographs and any other interface deemed useful. Data will be collected as the vehicle is operated, and will be initially stored in the memory of the on-board computer system and then later downloaded/transferred through a wired or wireless telecommunications network at predetermined intervals and/or locations, such as end of day, end of route, or other suitable time and/or location.

According to a second aspect of the present disclosure of an in-vehicle monitor for monitoring a status of a vehicle includes a means by which the data collected by the interfaces may be encrypted with a both a user (entity) defined and a hidden encryption key. The hidden key will be kept in an anonymous manner by a third party (such as the manufacturer) and released only upon order of the court.

According to another aspect of the present invention, data may be retrieved within a relatively short period of time (e.g., 30 days) from the vehicle itself. These data, when retrieved from the vehicle will include both the vehicle data and any recorded video and/or photo data. The period will be set to a relatively short period, during which time the video data will be preserved on the bus. A vehicle is likely to have a multitude of cameras, collecting many gigabytes of data each day, and can be configured to collect and store video/photographs of every passenger/rider that enters and exits the vehicle during the time period when the vehicle doors are opened. This information will be retrievable from the bus immediately following an accident or event should the need arise. However, the present invention innovates to fill a void in the art by providing a means of separating entire run time video and/or photo data from the interface data and more limited passenger/rider video and/or photo data taken only when the vehicle doors are opened. This data is manageable from the standpoint of data storage and can easily be stored for many years following the date of its creation. Further, this data may be retrieved should there be a need or question of liability. The vehicle data alone will be sufficient to determine if there was an anomaly in the operation of the vehicle on the day in question, allowing immediate retrieval of both the specific video and data for the incident.

According to yet another aspect of the present invention, there exists a means by which past vehicle data, as well as video and/or photo data (including or limited to passenger/rider video and/or photo data taken each time the vehicle door was opened) may be automatically or manually searched and flagged for potential anomalies. These anomalies may then be reviewed to assess any potential liability that may have arisen. One example of this behavior would include a search run to determine all times at which the vehicle exceeded the posted speed limit. The results of this search may be used both to assess any potential liability and to evaluate the performance of the driver. The data could also be used to assess flaws in vehicles, roads, or even designated routes. Further, should the vehicle be operated in an anomalous fashion (regardless of incident) the computer system will automatically retrieve and store the related video/photo information.

According to a specific embodiment of the invention, the searchable database which contains data collected during vehicle operation, can be configured to display the route that a vehicle followed from the time and place that a passenger/rider entered the vehicle until the time and place that the passenger/rider exited the vehicle. During this timeframe, the system can highlight the vehicle route, the vehicle speed and related dynamic vehicle data including any g-forces experienced by the vehicle that could impart injury to the passenger/rider. This functionality of the present invention allows vehicle operators/owners (e.g., transit authorities) to quickly identify whether an individual allegedly injured while on the vehicle was (1) present on the vehicle when the accident/event actually occurred, and (2) the accident/event could sustain the injury alleged by the passenger/rider. This system will be useful to debunk alleged injury and substantiate the extent of actual injury, thereby reducing the amount of fraudulent claims, hastening out-of-court settlements.

The present invention collects forensic quality data for the determination of the physical presence and experience of vehicle riders, and, more specifically, if passengers have been exposed to unusual vehicle behavior including swerving, sudden stops, assorted bumps, and unexpected movements. This data collected by the present invention allows a determination to be made of the specific movements of the vehicle during a specified time period. The time period may be flagged for review during the occurrence, immediately after or anytime in the future when analysis is needed.

In particular, the data may be used for introduction into courtroom evidence. The system will store the data in a manner that protects the chain-of-custody process so that the vehicle data and video/photograph data will be admissible evidence according to state and federal law. Still more specifically, the evidence may be used to defend plaintiffs' personal injury cases based on soft tissue damage or other physical injuries. Further, the present invention includes encryption and authentication software and systems to preserve the integrity and validity of the data collected for courtroom use. Additionally, the present invention may be used to detect and analyze flaws in vehicle design.

With the necessity of maintaining data archives for a large number of vehicles for a multitude of years, another problem arises. Data, particularly encoded video, necessitates massive storage facilities and large numbers of data storage servers. The present invention addresses this issue in an embodiment, by allowing the separation of vehicle data, which takes up relatively little space, from the much larger entire run time video and/or photograph data. By not saving the entire video beyond the initial storage on the vehicle, the accident data may be archived in an extremely efficient manner. In alternative embodiments, cameras collect video and/or photographs limited to every time a vehicle entry/exit opens in order to record evidence of every person that enters and exits the vehicle. This specific video/photo data may be linked with the vehicle data stored in the on-board computer and later transmitted to the storage system of the invention.

### EXAMPLE 1

### Transit Authority Bus

The present invention may, in an embodiment, be deployed to monitor a public transit vehicle, such as a bus, train, plane or boat. The present example will focus on deployment of the system on a bus. A plurality of cameras configured to take video and/or photographs are stationed at all necessary points on said bus, such as at preferred locations that provide a clear line of sight to all doors in order to acquire video and still images of each person entering and exiting the vehicle, thereby collecting data and preserving it on an on-board DVR or similar recording device. Additionally, other data collection devices, receivers, and sensors, such as an accelerometer, GPS locator and GPS timestamp may be installed. Data collected could also include: temperature (inside and outside); weather conditions; tire slip; roll, yaw, pitch; altitude; speed and changes to speed; GPS data; any available Radio Signals and the strength and source of those signals; vibration; sound level and changes; air pressure; light and changes; intrusion; moisture; humidity; inertia/gravitational forces; vehicle (OBD) error codes; vehicle weight; tire pressure; location of the device within the vehicle; engine RPM, brake pedal and accelerator pedal pressure (other OBD available data); and time/date. These interfaces constantly save their data on board as well. As video and/or photographs are recorded, they will be time-stamped so it may be viewed in real time or at a later date in conjunction with the vehicle data. In instances where multiple devices collect the same data (such as the speedometer and GPS speed), both may be collected for consistency and accuracy. It is not necessary for all data mentioned above to be collected in every situation, the decision of what to collect and store may be made based on the situation in which the system is being implemented.

The stored vehicle data, as well as the video and/or photographs, may be retrieved immediately from storage in the on-board computer system in the event of a vehicle accident or event. Further the data including the video and/or photo data may be retrieved so long as the video and/or photos are preserved on the vehicle and later transmitted and stored with the vehicle data, providing an extremely accurate account of the performance of that particular vehicle, as well as determining whether a person was on board the vehicle during an accident or event and/or sustained an injury that can be attributed to and correlated with the vehicle accident or event. Further, should a legal claim arise much later, for example at the end of the period of statutory limitations, the interface data will still provide more than sufficient information to recreate any potential anomalies with forensic software well after the video data has been overwritten.

### EXAMPLE 2

### Fruit Freight Transport

Another location in which the present invention might be deployed would be in a freight situation. Particularly one in which the cargo is fragile, such as fruit. In this example cameras might not be necessary, but the other interfaces could preserve and encrypt data related to the transport of a particular cargo or container. Should the container be subjected to anomalous movement, then the data will be noted and flagged for later review. Further, if the company is later informed of a complaint of bruised or battered produce, the company may look back at stored records to determine where the damage was incurred. The present invention might prove extremely useful to commodities companies interested in maintaining the value of their product by providing smooth transportation, this might be particularly important in the transport of fruit or other produce as well as in the case of hazardous substances.

While the invention has been described above in conjunction with specific embodiments, it is evident that many alternatives, modifications, permutations, and variations will become apparent to those skilled in the art in light of the foregoing description. Accordingly, it is intended that the present invention embraces all such alternatives, modifications, and variations as fall within the scope of the claims below.

I claim:

1. A system for acquiring electronic information and data transmitted to a computer and for storing said information and data for later retrieval, the system comprising:
one or more data retrieval devices located on a vehicle that receive raw data comprising vehicle event data, vehicle operation data, time data, location data, and/or passenger data and transmit said raw data to at least one on-board computer system located on said vehicle or at a remote location;
said one on-board computer system aided by memory receives said raw data from said one or more data retrieval devices and processes said raw data with a processor into encrypted and authenticated data and then stores said encrypted and authenticated data in said memory; and
at least one data storage device that can receive said encrypted and authenticated data downloaded from said memory of said on-board computer system and then compress and securely archive said encrypted and authenticated data in a data vault.

2. The system of claim 1 wherein said one or more data retrieval devices include some or all of: a GPS system; velocity, acceleration, and braking detection systems; an interface for the detection of G forces in any direction; and an interface for monitoring wheel direction and steering such as pitch, roll, yaw.

3. The system of claim 1 wherein said one or more data retrieval devices comprise one or more cameras with line of sight to doors of said vehicle for taking digital images of all passengers that embark and disembark from said vehicle during travel of said vehicle.

4. The system of claim 1 further comprising one or more encryption/authentication systems for the storage of said raw data, wherein said encryption/authentication systems requires one or more keys to access the received data.

5. The system of claim 1 further comprising an encryption/authentication systems that generates a checksum based on a combination of a temporal stamp and a hard-coded system ID, wherein said hard-coded system ID specifies a specific data retrieval device that collected said raw data and said vehicle in which said data retrieval device was located.

6. The system of claim 1 further comprising a wired or wireless interface allowing the retrieval of data from said memory of said on-board computer system.

7. The system of claim 1 further comprising a storage media interface capable of transferring data to one or more types of rewritable media, such as a portable hard drive, flash memory device or other re-writable media.

8. The system of claim 1 further comprising a means for extracting archived data from said at least one data storage device and then decrypting said archived data for forensic analysis or presentations.

9. The system of claim 3, further comprising:
one or more encryption/authentication systems for the storage of said encrypted and authenticated data, wherein said encryption/authentication systems requires one or more keys to access said encrypted and authenticated data in said storage;
said one or more encryption/authentication systems which generate a checksum based on a combination of a temporal stamp and a hard-coded system ID, wherein said hard-coded system ID specifies the specific onboard storage device which collected the data and the specific vehicle in which the device was located;
a wired or wireless interface allowing for the retrieval of said data from said memory of said on-board computer system;
a media interface capable of transferring said data to one or more types of rewritable media, such as a portable hard drive, flash memory device or other re-writable media; and
a decryptor for extracting said data for use in forensics or other software.

10. A system for acquiring electronic information and data transmitted to a remote computer and for storing said information and data for later retrieval, the system comprising:
one or more data retrieval devices located on a vehicle that receive raw data comprising vehicle event data, vehicle operation data, time data, location data, and/or passenger data and transmit said raw data to a computer system located at a remote location;
said computer system aided by memory receives said raw data from said one or more data retrieval devices and processes said raw data with an encryptor into encrypted and authenticated data and then compresses and securely archives said encrypted and authenticated data in a data vault; and
a decryptor that can access and retrieve said encrypted and authenticated data from said data vault.

11. The system of claim 10 wherein said one or more data retrieval devices comprise one or more of: a GPS system; velocity, acceleration, and braking detection systems; an interface for the detection of G forces in any direction; an interface for monitoring wheel direction and steering such as pitch, roll, yaw; and one or more cameras with line of sight to doors of said vehicle for taking digital images of all passengers that embark and disembark from said vehicle during travel of said vehicle.

12. The system of claim 10 wherein said encryptor requires one or more keys to access said encrypted and authenticated data.

13. The system of claim 10 wherein said encryptor generates a checksum based on a combination of a temporal stamp and a hard-coded system ID, wherein said hard-coded system ID specifies the specific onboard storage device which collected the data and the specific vehicle in which the device was located.

14. The system of claim 10 further comprising:
a decryptor for extracting said encrypted and authenticated data for use in forensics or other software.

15. A method for collecting data from one or more vehicles said method comprising the steps of:
acquiring said data from one or more data retrieval devices located on a vehicle that receive raw data comprising vehicle event data, vehicle operation data, time data, location data, and/or passenger data and transmit said raw data to at least one on-board computer system located on said vehicle or at a remote location;
converting said data with a processor aided by memory in an on-board computer into encrypted and authenticated data;
storing said encrypted and authenticated data with said memory of said onboard computer;
transmitting said encrypted and authenticated data to a computer system located at a remote location; and
archiving said encrypted and authenticated data in a secure data vault.

16. The method of claim 15 wherein said step of encrypting comprises generating a checksum based on a combination of a temporal stamp and a hard-coded system ID, wherein said hard-coded system ID specifies a specific data retrieval device that collected said data and said vehicle in which said data retrieval device was located.

17. The method of claim 15 wherein said one or more data retrieval devices comprise one or more of: a GPS system; velocity, acceleration, and braking detection systems; an interface for the detection of G forces in any direction; an interface for monitoring wheel direction and steering such as pitch, roll, yaw; and one or more cameras with line of sight to doors of said vehicle for taking digital images of all passengers that embark and disembark from said vehicle during travel of said vehicle.

18. The method of claim 15 further comprising extracting said data from said data vault and then decrypting said data for forensic analysis or other software.

19. The method claim 18 wherein said forensic analysis comprises identifying a vehicle event and determining whether a passenger was present on said vehicle during said vehicle event.

20. The method of claim 19 wherein said forensic analysis comprises identifying a vehicle event and determining whether said vehicle event could have caused injury to said passenger.
